(19) United States
(12) Patent Application Publication
(10) Pub. No.: US 2025/0384746 A1
(43) Pub. Date: Dec. 18, 2025

(54) MONEY DEPOSITING DEVICE

(71) Applicant: Glory Ltd., Himeji-shi (JP)

(72) Inventors: Hisashi ISHITOBI, Himeji-shi (JP); Tetsuya YAMAUCHI, Himeji-shi (JP)

(73) Assignee: Glory Ltd., Himeji-shi (JP)

(21) Appl. No.: 19/238,541

(22) Filed: Jun. 16, 2025

(30) Foreign Application Priority Data
Jun. 17, 2024 (JP) 2024-097204

(51) Int. Cl. G07F 19/00

(52) U.S. Cl. CPC G07F 19/202

(57) ABSTRACT

A money depositing device includes: a first storage unit that stores money received through an inlet; a second storage unit that stores a predetermined number of items of money, received through the inlet, in at least one predetermined denomination; a first security structure that restricts access to the first storage unit and removes a restriction on the access to the first storage unit with a first means in order to collect money stored in the first storage unit; and a second security structure that restricts access to the second storage unit and removes a restriction on the access to the second storage unit with a second means different from the first means in order to collect money stored in the second storage unit.

### CROSS-REFERENCE TO RELATED APPLICATION

This application claims priority to Japanese Patent Application No. 2024-097204 filed on Jun. 17, 2024, the entire disclosure of which is incorporated herein by reference.

### BACKGROUND

The technology disclosed herein relates to a money depositing device.

A conventional coupon issuing machine is installed in a store such as a supermarket. A customer of the store inserts coins into the coupon issuing machine. The coupon issuing machine issues the customer with a coupon corresponding to the amount of coins inserted. Installing the coupon issuing machine is advantageous to both of the customer who can convert surplus coins, for example, to a coupon and the store where the issued coupon is used.

The coins inserted into the coupon issuing machine are stored in a storage area. When the storage area is almost full, an indicator notifies a staff member of the store to empty the storage area.

### SUMMARY

The technology disclosed herein relates to a money depositing device. The money depositing device includes:
a first storage unit that stores money received through an inlet;
a second storage unit that stores a predetermined number of items of money, received through the inlet, in at least one predetermined denomination;
a first security structure that restricts access to the first storage unit and removes a restriction on the access to the first storage unit with a first means in order to collect money stored in the first storage unit; and
a second security structure that restricts access to the second storage unit and removes a restriction on the access to the second storage unit with a second means different from the first means in order to collect money stored in the second storage unit.

### BRIEF DESCRIPTION OF THE DRAWINGS

FIG. 1 is a diagram illustrating a money handling system built in a store and including a money depositing device.

FIG. 2 is a block diagram of the money handling system.

FIG. 3 is a diagram illustrating the external appearance of the money depositing device.

FIG. 4 is a diagram illustrating an internal structure of the money depositing device.

FIG. 5 is a diagram illustrating a state in which a hinged door of the money depositing device is open and a state in which a cover covering a second storage unit is open.

FIG. 6 is a diagram illustrating a state in which a first storage unit is pulled out from the money depositing device.

FIG. 7 is a diagram illustrating an internal structure of a money depositing device according to a variation.

FIG. 8 is a diagram illustrating a state in which a first storage unit is pulled out from the money depositing device of the variation.

FIG. 9 shows a method of setting a shortage in the number of coins in a first money handling device.

FIG. 10A is a flowchart related to the collaborative work of the first money handling device and a management device.

FIG. 10B is a flowchart related to the collaborative work of the management device and the money depositing device.

FIG. 11 is a flowchart related to a process of a money depositing device according to a variation.

FIG. 12 is a flowchart related to a variation of the process of the money depositing device.

### DETAILED DESCRIPTION OF THE DRAWINGS

Since money is deposited in the coupon issuing machine, the coupon issuing machine can be called a money depositing device. Conventional money depositing devices only have the function of issuing a coupon corresponding to the coins inserted by a customer.

In stores where a money depositing device is installed, a money handling device is also installed to perform deposit processing for depositing the store's sales proceeds and withdrawal processing for withdrawing change used in the store. The store can obtain multiple operational benefits if the money depositing device and the money handling device can operate in coordination with each other.

The technique disclosed herein enhances the convenience of the money depositing device.

The technology disclosed herein relates to a money depositing device. The money depositing device includes:
a first storage unit that stores money received through an inlet;
a second storage unit that stores a predetermined number of items of money, received through the inlet, in at least one predetermined denomination;
a first security structure that restricts access to the first storage unit and removes a restriction on the access to the first storage unit with a first means in order to collect money stored in the first storage unit; and
a second security structure that restricts access to the second storage unit and removes a restriction on the access to the second storage unit with a second means different from the first means in order to collect money stored in the second storage unit.

The money depositing device includes two types of storage units, i.e., the first storage unit and the second storage unit. The money depositing device stores money received through the inlet in the first storage unit or the second storage unit. The money depositing device performs a money depositing process.

The money stored in the first storage unit is collected from the first storage unit. The money stored in the second storage unit is collected from the second storage unit. Since the first security structure restricts access to the first storage unit, the security of the first storage unit is ensured. The restriction on the access to the first storage unit is removed with the first means.

Since the second security structure restricts access to the second storage unit, the security of the second storage unit is ensured. The restriction on the access to the second storage unit is removed with the second means.

For example, a first user can collect the first storage unit by using the first means, but cannot collect the second storage unit. For example, a second user can collect the second storage unit by using the second means, but cannot collect the first storage unit. Providing separate security for each of the first storage unit and the second storage unit allows the money depositing device to have multiple functions.

The second storage unit stores a predetermined number of items of money in at least one predetermined denomination. For example, a staff member of the store where the money depositing device is installed can collect the money from the second storage unit, and replenish a storage unit of a money handling device installed in the store with the collected money.

Money stored in the storage unit of the money handling device may be withdrawn as change or a change fund, for example. Part of the money inserted in the money depositing device can be used as operation money for the store. The money depositing device disclosed herein is more convenient than conventional money depositing devices.

The money depositing device may further include a transport unit that transports money received through the inlet to the second storage unit or the first storage unit such that the predetermined number of items of money of the at least one predetermined denomination is stored preferentially in the second storage unit over the first storage unit.

The second storage unit is more likely to store the predetermined number of items of money in a predetermined denomination. Among the money stored in the second storage unit, the predetermined number of items of money in the predetermined denomination can be used for a specific purpose.

The second storage unit may store a combination of multiple denominations of money in a single storage area in a mixed manner, the number of items of the money for each denomination being predetermined.

The second storage unit that stores the money in the mixed manner can be reduced in size. As described above, in the case in which the money stored in the second storage unit is stored in the storage unit of the money handling device, the money handling device generally has a function of sorting the inserted money by denomination. The money stored in the second storage unit in the mixed manner is sorted by the money handling device according to denominations. The second storage unit may store, in a mixed manner, money that is required as, for example, change or a change fund and which is a combination of multiple denominations of money, the number of items of the money being set for each denomination.

The money depositing device may further include a reception unit that receives a denomination and the number of items of money to be stored in the second storage unit, the denomination and the number being set based on operation by a user.

The user can freely set the denomination and the number of items of money to be stored in the second storage unit.

Money collected from the second storage unit may be stored in a storage unit of a money handling device that performs at least a money withdrawing process.

The money depositing device may include a reception unit that receives a denomination and the number of items of money to be stored in the second storage unit, the denomination and the number being set based on an inventory amount of the storage unit of the money handling device.

In a case in which the money collected from the second storage unit is stored in the storage unit of the money handling device, the denomination and the number of items of money for replenishment of the storage unit of the money handling device are determined based on the inventory amount of the storage unit of the money handling device. The denomination and the number of items of money to be stored in the second storage unit may be set based on the inventory amount of the storage unit of the money handling device.

The first security structure and the second security structure may differ from each other in a key for a lock or a type of lock. The types of lock include: a mechanical lock including, for example, a key and a cylinder; and a so-called electromagnetic lock. The first means and the second means described above are keys different from each other, for example.

The first means and the second means are, for example, different IDs or different personal identification numbers (PINs) for unlocking the electromagnetic locks, or different numbers for unlocking the locks.

The security of the first storage unit and the security of the second storage unit are independent of each other.

The money depositing device may further include a housing that houses the first storage unit and the second storage unit and has an opening that is opened for the access to the first storage unit and the second storage unit.

The second storage unit may be located at a position closer to the opening than the first storage unit.

When the opening of the housing is opened, both the first storage unit and the second storage unit are exposed to the outside of the housing. Even if both the first storage unit and the second storage unit are exposed to the outside of the housing, the security of the first storage unit and the security of the second storage unit can be individually ensured by the first security structure and the second security structure.

Since the second storage unit is located at the position relatively close to the opening of the housing, the user can easily access the second storage unit. The second user can easily collect the money from the second storage unit.

The housing may further have a door which opens and closes the opening and which has a lock.

The second storage unit may be located on the door and may move along with opening and closing of the door.

When the door is moved to open the opening of the housing, the second storage unit moves to the outside of the housing. The user can easily collect the money from the second storage unit. Further, if the door moves a great distance from the opening (for example, if the door is a hinged door, and the hinged door is greatly turned), the second storage unit moves away from the opening of the housing; therefore, the user can easily access the first storage unit.

The second storage unit may have a slot used to insert money into the second storage unit.

The second security structure may have a shutter that closes the slot in conjunction with unlocking the lock of the door.

With the door open, the slot of the second storage unit is closed by the shutter. This configuration enhances the security of the second storage unit. For example, to access the first storage unit, a user unlocks the lock of the door and opens the door to open the opening of the housing; however, access of the user to the second storage unit is restricted.

The second storage unit may be a pouch.

The user can detach the pouch of the second storage unit from the money depositing device, and can insert the money in the pouch into the money handling device, for example.

The first storage unit may include storage areas independent of each other.

If the first storage unit has a large capacity including storage areas, the frequency of collecting the money from the first storage unit is reduced. A cost required for operation of the money depositing device is reduced.

The storage areas of the first storage unit may store money of different denominations. That is, the first storage unit may store money according to denomination.

The first storage unit and the second storage unit may have configurations in which they do not feed out money stored therein. That is, the money depositing device may have a configuration in which it executes the money depositing process and does not execute the money withdrawing process.

The money depositing device may further include an issuing unit that issues a valuable medium corresponding to an amount of money received through the inlet.

The valuable medium is, for example, a coupon or a voucher which can be used in a store. The issuance of the valuable medium serves as an incentive for a customer of the store to insert money into the money depositing device.

A money depositing device disclosed herein includes:
a first storage unit that stores money received through an inlet;
a second storage unit that stores a predetermined number of items of money, received through the inlet, in at least one predetermined denomination;
a housing that houses the first storage unit and the second storage unit, the housing having an opening that is opened for access to the first storage unit and the second storage unit and a door that opens and closes the opening,
the second storage unit being fixed to an inner side of the door and moving along with opening and closing of the door.

When the door is moved to open the opening of the housing, the second storage unit moves to the outside of the housing. The user can easily access the second storage unit. Further, if the door moves a great distance from the opening (for example, if the door is a hinged door, and the hinged door is greatly turned), the second storage unit moves away from the opening of the housing; therefore, the user can easily access the first storage unit as well. The convenience of the money depositing device is improved.

An embodiment of a money depositing device will be described below with reference to the drawings. The money depositing device described herein is an example.

### (Money Handling System)

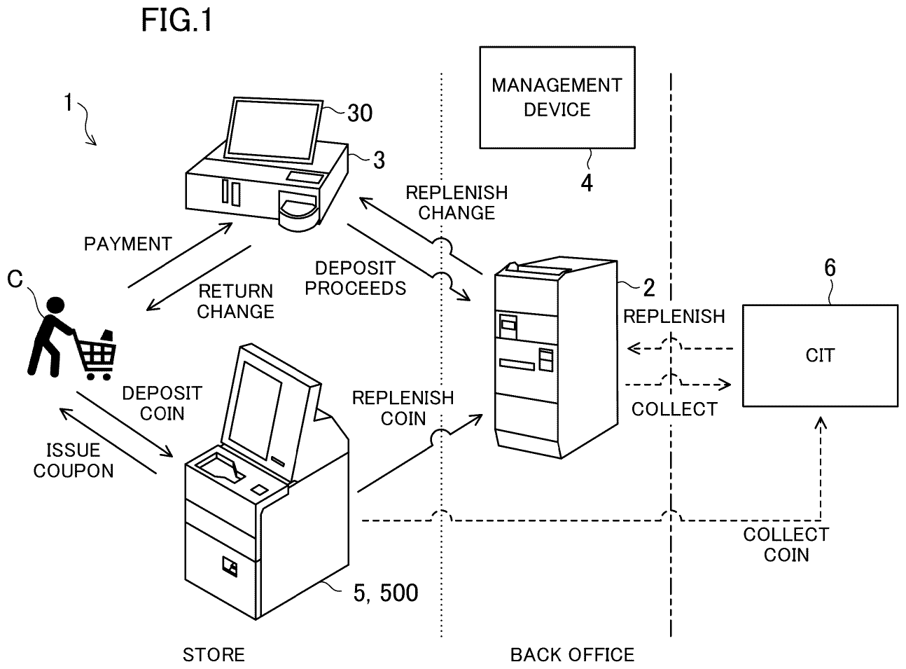

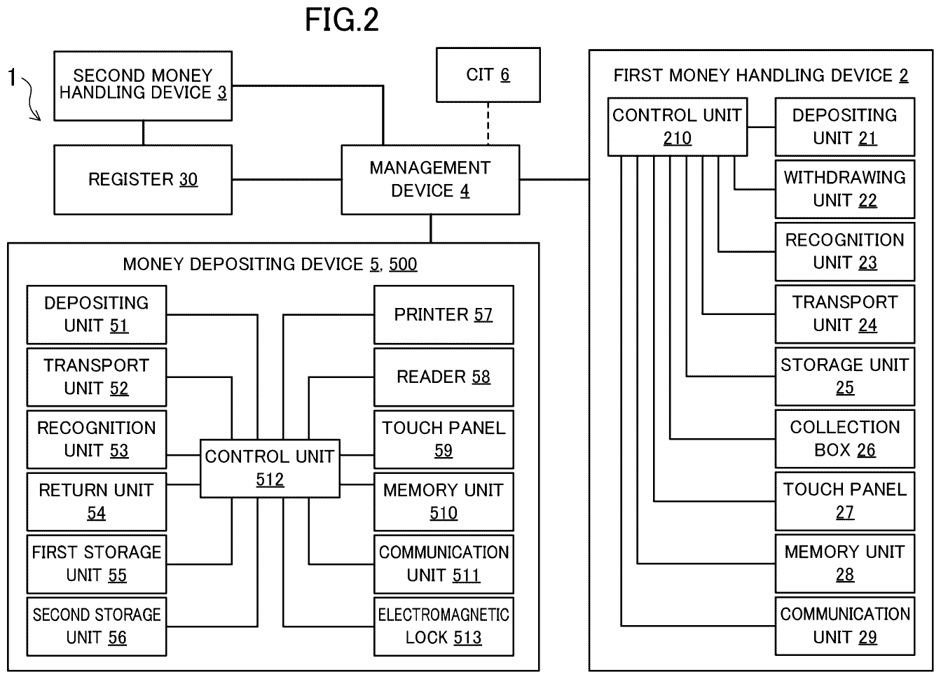

FIG. 1 is a diagram illustrating a money handling system 1 including a money depositing device 5. FIG. 2 is a block diagram of the money handling system 1. The money handling system 1 is built in a store. The money handling system 1 performs deposit and withdrawal operations of money necessary for operation of the store. The money includes a banknote and a coin.

The money handling system 1 includes a first money handling device 2. The first money handling device 2 is installed in a back office of the store. The first money handling device 2 performs withdrawals of change funds to be used in the store. The first money handling device 2 can also perform deposits of the proceeds of the store. The first money handling device 2 executes a withdrawing process and a depositing process.

As shown in FIG. 2, the first money handling device 2 includes a depositing unit 21, a withdrawing unit 22, a recognition unit 23, a transport unit 24, a storage unit 25, a collection box 26, a touch panel 27, a memory unit 28, a communication unit 29, and a control unit 210.

The depositing unit 21 receives money to be deposited in the first money handling device 2. The money to be deposited is, for example, the proceeds of the store. The withdrawing unit 22 holds money to be withdrawn from the first money handling device 2. The money to be withdrawn is, for example, the change fund to be paid to a customer of the store as change. The recognition unit 23 recognizes money. The recognition unit 23 recognizes at least the denomination and authenticity of the money, and counts the money. The transport unit 24 transports money. The storage unit 25 stores money deposited in the first money handling device 2. The storage unit 25 feeds out money to be withdrawn from the first money handling device 2. The storage unit 25 stores money for each denomination, for example.

The collection box 26 stores money collected from the first money handling device 2. As will be described later, a person in charge of a cash-in-transit (CIT 6) company collects money from the first money handling device 2 by detaching the collection box 26 storing the money from the first money handling device 2. The touch panel 27 is an operation unit that receives an operation by an operator. The touch panel 27 serves also as a display unit. The memory unit 28 memorizes various types of information. The memory unit 28 memorizes, for example, the inventory amount of the money stored in the storage unit 25. The inventory amount includes at least the denomination and the number of items of money. The inventory amount may include the total amount of money. The communication unit 29 performs communication between devices in the money handling system 1. The control unit 210 controls each unit to implement the process executed by the first money handling device 2.

The money handling system 1 includes a second money handling device 3. The second money handling device 3 is installed, for example, at a checkout counter of the store. The second money handling device 3 is connected to a register 30. The register 30 is operated by, for example, a staff member of the store, and registers a product purchased by a customer C. The customer C may operate the register 30. The second money handling device 3 is used for a checkout process between the store and the customer C. The second money handling device 3 performs a depositing process of money, which is a payment made by the customer C, and/or a withdrawing process of money, which is change paid to the customer C. The second money handling device 3 is operated by a staff member of the store or the customer C, for example. The second money handling device 3 can store money. The money stored in the second money handling device 3 is the money paid by the customer C, i.e., proceeds, and the change to be paid to the customer C.

The money handling system 1 includes a management device 4. The management device 4 is connected to the first money handling device 2, the second money handling device 3, and the register 30. The management device 4 can transmit and receive data to and from the first money handling device 2, the second money handling device 3, or the register 30. The management device 4 can also transmit and receive data to and from a system of the CIT 6. The management device 4 manages at least the inventory amounts of the first money handling device 2 and the second money handling device 3.

The first money handling device 2, the second money handling device 3, the register 30, and the management device 4 are basic elements of the money handling system 1. That is, the first money handling device 2, the second money handling device 3, the register 30, and the management device 4 can manage the proceeds and prepare the change in the store. More specifically, a staff member of the store collects the proceeds from the second money handling device 3. The staff member of the store deposits the collected proceeds into the first money handling device 2 as described above. The staff member of the store also withdraws the change fund from the first money handling device 2. The second money handling device 3 is replenished with the change fund. When the storage unit 25 of the first money handling device 2 is almost full, a person in charge of CIT 6 collects the money from the first money handling device 2. The person in charge of CIT 6 may acquire information indicating that the storage unit 25 of the first money handling device 2 is almost full, via the management device 4. The person in charge of CIT 6 also replenishes the first money handling device 2 with the change fund as necessary, because only a deposit of the proceeds from the second money handling device 3 may result in a shortage of the change fund of a specific denomination, for example.

The store is charged a cost if the first money handling device 2 is replenished by a person in charge of CIT 6. There is a demand from a store to reduce the frequency of replenishment of the first money handling device 2 in order to reduce operating costs.

The money handling system 1 includes a money depositing device 5. The money depositing device 5 can reduce the frequency of replenishment of the first money handling device 2. The money depositing device 5 is installed in a store. Coins are deposited in the money depositing device 5. The coins to be deposited in the money depositing device 5 are surplus coins owned by the customer C of the store. The customer C of the store deposits, for example, coins stored at home into the money depositing device 5. The money depositing device 5 issues a coupon corresponding to the amount of deposited coins to the customer C. The issuance of the coupon serves as an incentive for the customer C to deposit coins into the money depositing device 5. Deposits of a large amount of coins into the money depositing device 5 can be expected. Instead of issuing the coupon, the money depositing device 5 may issue a voucher.

The money depositing device 5 stores the deposited coins. As will be described later, part of the coins stored in the money depositing device 5 is used to replenish the first money handling device 2 as the change fund. The replenishment of the first money handling device 2 with the change fund can reduce the frequency of the replenishment of the change fund by a person in charge of CIT 6. The store can reduce the cost for the CIT 6. The customer C can use the issued coupon in the store. Installing the money depositing device 5 in the store provides another advantage that it increases the chances for the customer C to visit the store.

When the storage unit of the money depositing device 5 is almost full, the person in charge of CIT 6 collects the coins from the money depositing device 5 as indicated by the arrow in broken line in FIG. 1.

### (Money Depositing Device)

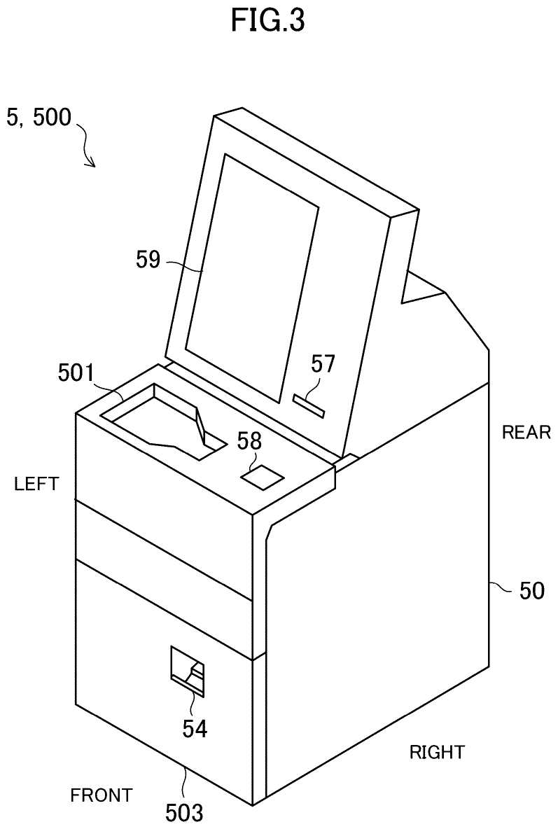

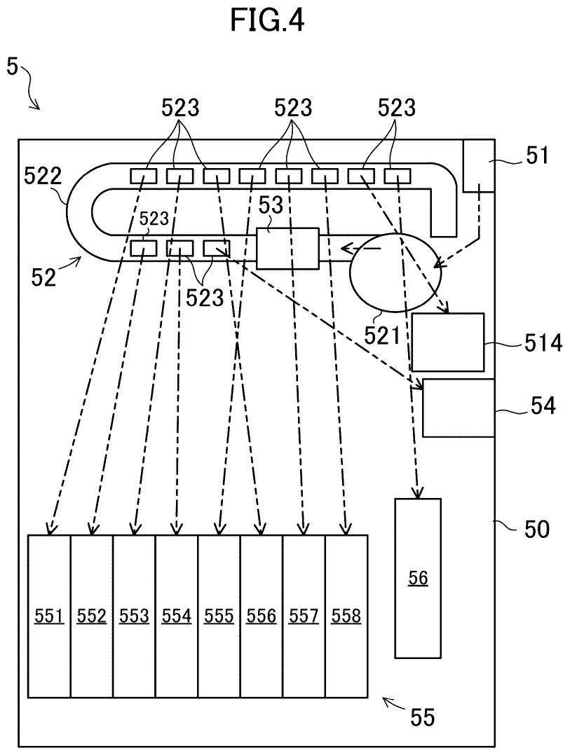

FIG. 3 is a diagram illustrating the external appearance of the money depositing device 5. FIG. 4 is a diagram illustrating an internal structure of a housing 50 of the money depositing device 5. The money depositing device 5 has a depositing unit 51. The depositing unit 51 receives deposited coins. The depositing unit 51 has an inlet 501. As shown in FIG. 3, the inlet 501 is formed in the housing 50. The depositing unit 51 can receive coins at a time through the inlet 501. The money depositing device 5 has a transport unit 52. The transport unit 52 transports coins. The transport unit 52 has a rotary disk 521. The transport unit 52 also has a transport path 522. The depositing unit 51 transmits the deposited coins to the rotary disk 521. The rotary disk 521 delivers the coins transmitted from the depositing unit 51 one by one to the transport path 522. The transport unit 52 transports the coins one by one along the transport path 522.

The money depositing device 5 has a recognition unit 53. The recognition unit 53 is located in the transport path 522. The recognition unit 53 includes, for example, a sensor such as a magnetic sensor, or an optical sensor such as an image sensor, and recognizes coins. The recognition unit 53 recognizes at least the denominations and authenticity of coins and counts the coins.

The transport unit 52 has sorting units 523. The transport unit 52 in the illustrated example has 11 sorting units 523. The sorting units 523 are arranged along the transport path 522 downstream of the recognition unit 53. As indicated by arrows of two-dot-dash lines in FIG. 4, the sorting unit 523 is connected to a return unit 54, a first storage unit 55, a second storage unit 56, or a third storage unit 514, which will be described later, through a chute. The sorting unit 523 transmits the coins being transported by the transport path 522 to the return unit 54, the first storage unit 55, the second storage unit 56, or the third storage unit 514 according to a recognition result. The third storage unit 514 is a storage unit that stores counterfeit coins, or coins suspected of being counterfeit coins.

The money depositing device 5 has the return unit 54. Coins which are not accepted by the money depositing device 5 are returned to the customer C through the return unit 54.

The money depositing device 5 has the first storage unit 55. The first storage unit 55 stores coins. In the example of FIG. 4, the first storage unit 55 includes eight storage areas 551 to 558. Each of the storage areas 551 to 558 is a pouch. The storage areas 551 to 558 are each connected to the different sorting units 523. The eight storage areas 551 to 558 store coins according to denominations, for example. The storage areas 551 to 558 cannot feed out the coins stored therein.

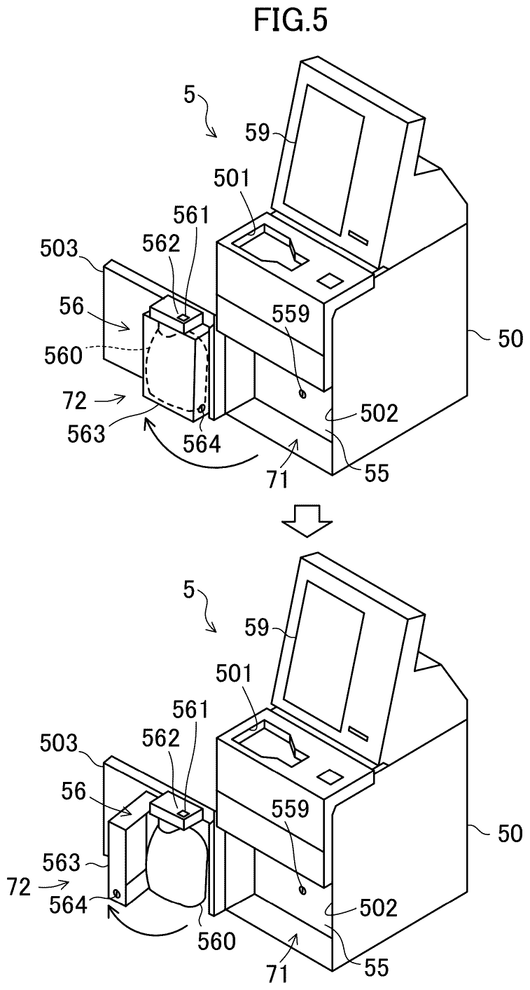

The money depositing device 5 has the second storage unit 56. The second storage unit 56 stores coins. As shown in FIG. 5, the second storage unit 56 has a pouch 560. The second storage unit 56 is connected to the sorting unit 523 different from those connected to the storage areas 551 to 558 of the first storage unit 55. The second storage unit 56 cannot feed out the coins stored therein. The structure of the second storage unit 56 will be described in detail later.

The second storage unit 56 stores coins for replenishment of the first money handling device 2 as the change fund. A staff member of the store accesses the second storage unit 56 to replenish the first money handling device 2 with the coins stored in the second storage unit 56. The first storage unit 55 stores coins which are not for replenishment of the second money handling device 3. A person in charge of CIT 6 accesses the first storage unit 55 to collect the coins stored in the first storage unit 55.

As shown in FIG. 2, the money depositing device 5 has a printer 57. The printer 57 prints a coupon. The printer 57 is an example of an issuing unit that issues a valuable medium. The printer 57 may print a voucher instead of the coupon.

The money depositing device 5 has a reader 58. The reader 58 reads information on the customer C who uses the money depositing device 5. The reader 58 may be, for example, a reader of a code identifying the customer C.

The money depositing device 5 has a touch panel 59. The touch panel 59 is an operation unit that receives an operation by an operator. The touch panel 59 serves also as a display unit.

The money depositing device 5 has a memory unit 510. The memory unit 510 memorizes various types of information. The memory unit 510 memorizes the inventory amount of money stored in the first storage unit 55 and the inventory amount of money stored in the second storage unit 56. The inventory amount includes at least the denomination and the number of coins. The inventory amount may include the total amount of money.

The money depositing device 5 has a communication unit 511. The communication unit 511 performs communication between devices in the money handling system 1.

The money depositing device 5 has a control unit 512. The control unit 512 controls each unit to implement the process executed by the money depositing device 5.

### (Structure of Second Storage Unit)

As shown in FIG. 5, the housing 50 of the money depositing device 5 has an opening 502. The opening 502 is on the front side of the money depositing device 5. The front side of the money depositing device 5 is the side where the inlet 501, the return unit 54, and the touch panel 59 are arranged. The customer C stands in front of the money depositing device 5 and operates the money depositing device 5.

The housing 50 has a door 503. The door 503 opens and closes the opening 502. The door 503 is a hinged door. The door 503 turns about an axis extending in the vertical direction. The door 503 is not limited to the hinged door. The door 503 may be a drawer-type door.

The money depositing device 5 has an electromagnetic lock 513 (see FIG. 2). The electromagnetic lock 513 locks the door 503. The electromagnetic lock 513 is electrically connected to the control unit 512. The control unit 512 unlocks the electromagnetic lock 513 when a staff member of the store or a person in charge of CIT 6 performs predetermined operation through the touch panel 59. The staff member of the store or the person in charge of CIT 6 can open the door 503 to open the opening 502. The staff member of the store opens the door 503 to collect the coins in the second storage unit 56. The person in charge of CIT 6 opens the door 503 to collect the coins in the first storage unit 55. As will be described later, the money depositing device 5 has a first security structure 71 and a second security structure 72. The first security structure 71 is related to the security of the first storage unit 55. The second security structure 72 is related to the security of the second storage unit 56. The electromagnetic lock 513 is an element common to both the first security structure 71 and the second security structure 72.

As shown in FIG. 5, the second storage unit 56 is fixed to the inner side of the door 503. The first storage unit 55 is located at the rear in the housing 50. The second storage unit 56 is located at a position closer to the opening 502 than the first storage unit 55. When the door 503 moves, the second storage unit 56 also moves to the outside of the housing 50 together with the door 503 as shown in the upper diagram of FIG. 5. The second storage unit 56 is easier to access than the first storage unit 55.

The second storage unit 56 has a slot 561. The slot 561 is a port connected to the chute and used to insert coins into the second storage unit 56. When the second storage unit 56 moves together with the door 503, the slot 561 also moves together with the door 503.

The second storage unit 56 has a shutter 562 that closes the slot 561. The shutter 562 is an element of the second security structure 72. The shutter 562 is opened and closed by an electric motor. The control unit 512 causes the shutter 562 to close the slot 561 in conjunction with unlocking the electromagnetic lock 513 of the door 503. The access to the second storage unit 56 through the slot 561 is restricted while the door 503 is open.

The second storage unit 56 also has a cover 563. The cover 563 covers the pouch 560 of the second storage unit 56. The cover 563 restricts the access to the pouch 560. The cover 563 has a second cylinder lock 564. The second cylinder lock 564 is unlocked and locked with a key managed by a staff member of the store. If the second cylinder lock 564 is unlocked, it is possible to open the cover 563 and reveal the pouch 560 as shown in the lower diagram of FIG. 5. The staff member of the store can detach the pouch 560 containing coins from the money depositing device 5. The cover 563 and the second cylinder lock 564 are elements of the second security structure 72. The key managed by the staff member of the store is an example of a second means that removes the restriction on access to the second storage unit 56.

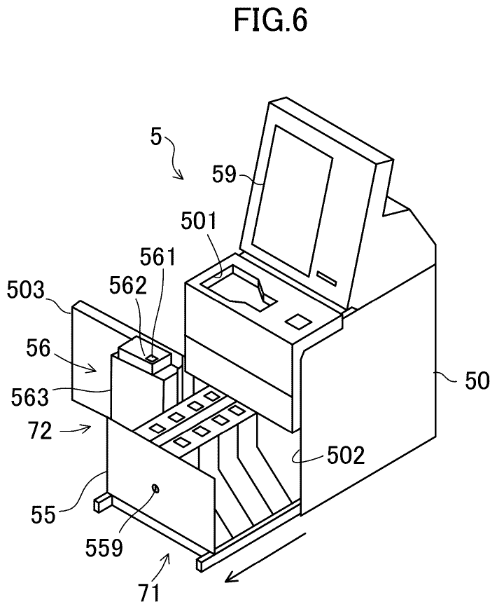

The turning angle of the door 503 is relatively large. When the door 503 is opened wide, the second storage unit 56 fixed on the inner side of the door 503 moves away from the opening 502 of the housing 50. As shown in FIG. 6, the first storage unit 55 can be pulled out of the housing 50 through the opening 502. The first storage unit 55 is a unit including the storage areas 551 to 558 (i.e., pouches). When the first storage unit 55 is pulled out of the housing 50, all the pouches are pulled out of the housing 50.

As shown in FIG. 5 or 6, the first storage unit 55 has a first cylinder lock 559. The first cylinder lock 559 is unlocked and locked with a key managed by a person in charge of CIT 6. If the first cylinder lock 559 is unlocked, the first storage unit 55 can be pulled out of the housing 50 as shown in FIG. 6. The person in charge of CIT 6 can collect the coins from the first storage unit 55. The first cylinder lock 559 is an element of the first security structure 71. The key managed by the person in charge of CIT 6 is an example of a first means that removes the restriction on access to the first storage unit 55.

When the door 503 of the housing 50 is opened, both the first cylinder lock 559 and the second cylinder lock 564 are exposed to the outside of the housing 50. At this time, for example, the key for the first cylinder lock 559 is managed by the person in charge of CIT 6, and the key for the second cylinder lock 564 is managed by the staff member of the store. The person in charge of CIT 6 is restricted from making access to the second storage unit 56. Further, the staff member of the store is restricted from making access to the first storage unit 55.

The first security structure 71 allows the person in charge of CIT 6 as a first user to access the first storage unit 55 to collect the money stored in the first storage unit 55, and restricts the staff member of the store as a second user from making access to the first storage unit 55.

In other words, the first security structure 71 restricts access to the first storage unit 55, and removes the restriction on access to the first storage unit 55 with the first means to collect the money stored in the first storage unit 55. The second security structure 72 allows the staff member of the store to access the second storage unit 56 to collect the money stored in the second storage unit 56, and restricts the person in charge of CIT 6 from making access to the second storage unit 56.

In other words, the second security structure 72 restricts access to the second storage unit 56, and removes the restriction on access to the second storage unit 56 with the second means to collect the money stored in the second storage unit 56. In the money depositing device 5, the key for the first cylinder lock 559 related to the first storage unit 55 and the key for the second cylinder lock 564 related to the second storage unit 56 differ from each other; therefore, access restriction differs between the first storage unit 55 and the second storage unit 56. The authority to access the first storage unit 55 and the authority to access the second storage unit 56 are independent of each other.

Instead of the different keys for the locks, the lock related to the first storage unit 55 and the lock related to the second storage unit 56 may be of different types. For example, the lock related to the first storage unit 55 may be an electromagnetic lock, and the lock related to the second storage unit 56 may be a mechanical lock including a cylinder lock and a key. Conversely, the lock related to the first storage unit 55 may be a mechanical lock, and the lock related to the second storage unit 56 may be an electromagnetic lock.

### (Variations of Money Depositing Device)

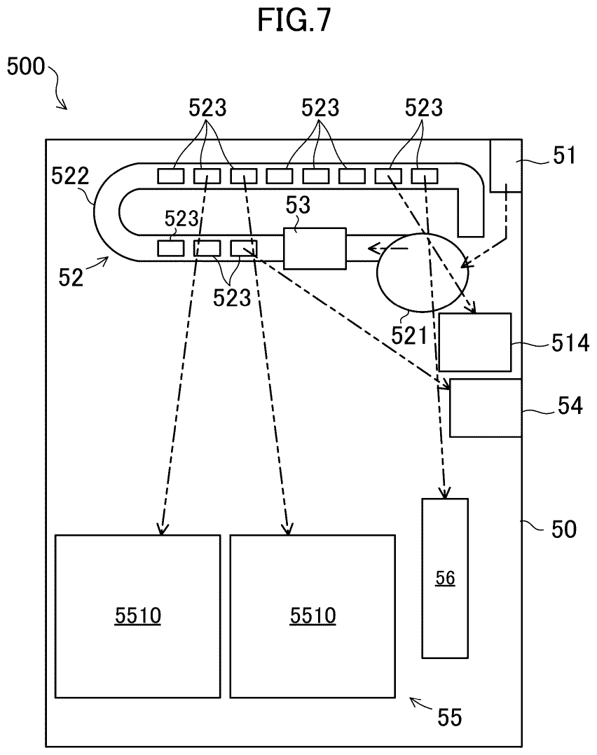

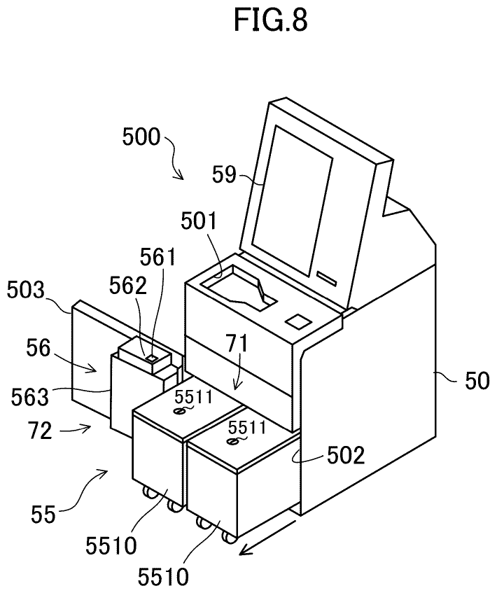

FIGS. 7 and 8 are diagrams illustrating a variation of the money depositing device. A money depositing device 500 according to the variation differs from the money depositing device 5 of FIG. 4 in the structure of the first storage unit 55. The first storage unit 55 of the money depositing device 5 described above has pouches. The first storage unit 55 of the money depositing device 500 has a bin instead of the pouch.

The first storage unit 55 of the money depositing device 500 has bins 5510. The bins 5510 form storage areas of the first storage unit 55. The money depositing device 500 in the illustrated example has two bins 5510. As indicated by arrows of two-dot-dash lines in FIG. 7, the two bins 5510 are each connected to different sorting units 523 through the chutes. The bins 5510 do not feed out the coins stored therein.

The bins 5510 each have a box-like shape, as shown in FIG. 8. The capacity of a single bin 5510 is greater than the capacity of a single pouch. The two bins 5510 are arranged, for example, in the left-right direction in the housing 50 of the money depositing device 500. The left-right direction is a direction orthogonal to the front-rear direction of the money depositing device 500. The person in charge of CIT 6 can pull out the two bins 5510 separately from the housing 50. As in the money depositing device 5 of FIG. 6, the second storage unit 56 does not interfere with the bins 5510 of the first storage unit 55.

Each of the two bins 5510 has a cylinder lock 5511. The person in charge of CIT 6 can open the lid of each of the two bins 5510 using a key and collect the coins from the bins 5510. The cylinder lock 5511 is an element of the first security structure 71. The staff member of the store cannot open the lids of the bins 5510.

### (Movement of Money in Money Handling System)

In the money handling system 1, the money depositing device 5, 500 stores coins for replenishment of another money handling device such as the first money handling device 2, for example. The money depositing device 5, 500 stores coins for replenishment of another money handling device in the second storage unit 56 and stores coins other than those for replenishment in the first storage unit 55. The coins for replenishment to be stored in the second storage unit 56 are set by the staff member of the store, for example. The staff member of the store can set the coins for replenishment to be stored in the second storage unit 56 by determining the shortage of coins, based on the inventory amount of each denomination in the first money handling device 2, for example.

The staff member of the store sets the coins for replenishment to be stored in the second storage unit 56 by using, for example, the touch panel 59 of the money depositing device 5, 500. The touch panel 59 is an example of a reception unit that receives the denomination and the number of items of money to be stored in the second storage unit 56 which are set based on the operation by the user.

Specifically, the staff member of the store designates the denomination of coins and the number of coins. The staff may designate not only a single denomination but also multiple denominations. The staff may designate a uniform number of coins regardless of denominations, or may designate different numbers coins for each denomination. The staff may set the coins for replenishment to be stored in the second storage unit 56, through the management device 4, for example. The staff may set the coins for replenishment to be stored in the second storage unit 56 by using the touch panel 27 of the first money handling device 2, for example. The set information is provided to the money depositing device 5, 500 through the management device 4. The communication unit 511 of the money depositing device 5, 500 is also an example of a reception unit that receives the denomination and the number of items of money to be stored in the second storage unit 56 which are set based on the operation by the user.

Once the denomination and the number of coins to be stored in the second storage unit 56 are set, the transport unit 52 of the money depositing device 5, 500 controls the sorting units 523 so that the set number of items of money of the set denomination, among the coins received through the inlet 501, is stored preferentially in the second storage unit 56 over the first storage unit 55. The second storage unit 56 can store the set number of coins of the set denomination as quickly as possible. Coins for replenishment of the first money handling device 2 are secured quickly. The transport unit 52 also controls the sorting units 523 so that coins not for storage in the second storage unit 56 are stored in the first storage unit 55.

If multiple denominations are set, the second storage unit 56 stores a combination of coins in multiple denominations in a single storage area in a mixed manner, the number of coins for each denomination being predetermined. The mixed storage of coins of multiple denominations in the second storage unit 56 enables a reduction in the size of the second storage unit 56. The money depositing device 5 is reduced in size.

For example, before start of store operation, a staff member of the store removes the pouch of the second storage unit 56 from the money depositing device 5, 500 and replenishes (i.e., deposits coins) the first money handling device 2 with coins in the pouch through the depositing unit 21 of the first money handling device 2 according to the above-described procedure. The first money handling device 2 is replenished with the change fund. The timing of replenishing the first money handling device 2 with the change fund is not limited to before start of store operation.

The number of coins for each denomination in the pouch removed from the money depositing device 5, 500 is grasped by at least the money depositing device 5, 500 or the management device 4. The inventory amount of the storage unit 25 of the first money handling device 2 before the storage unit 25 is replenished with the coins in the pouch is grasped by at least the first money handling device 2 or the management device 4. Accordingly, it is possible to grasp the situation in advance in which the amount of storage in the storage unit 25 of the first money handling device 2 exceeds the capacity of the storage unit 25 when the storage unit 25 is replenished with the coins in the pouch. If the storage amount seems to exceed the capacity, the management device 4 or the first money handling device 2 may notify the staff member of the store to stop the replenishment of the first money handling device 2 with the coins. In this case, the staff member of the store or the management device 4 may automatically request the person in charge of CIT 6 to collect money from the first money handling device 2.

If the inventory amount of the storage unit 25 of the first money handling device 2 decreases after the stop of replenishment of the first money handling device 2 with the coins, the first money handling device 2 or the management device 4 may notify the staff member of the store to urge coin replenishment which has been stopped.

Instead of the staff member of the store setting coins for replenishment to be stored in the second storage unit 56 of the money depositing device 5, 500, the first money handling device 2, for example, may automatically set coins for replenishment to be stored in the second storage unit 56 of the money depositing device 5, 500, based on the inventory amount of the storage unit 25.

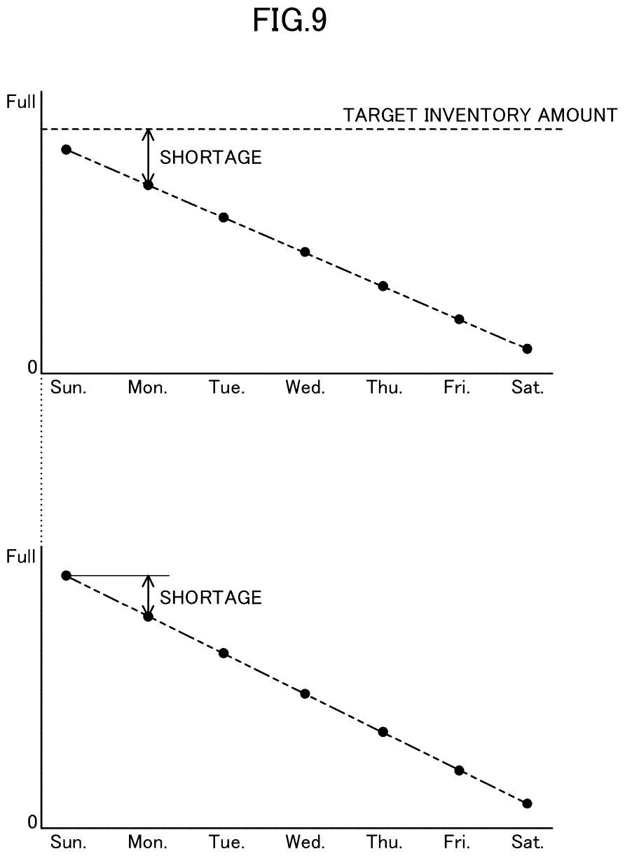

The first money handling device 2 can set the coins for replenishment as follows. FIG. 9 shows the concept of setting the coins for replenishment. The vertical axis of the graph of FIG. 9 indicates the inventory amount of the storage unit 25 of the first money handling device 2. The inventory amount of the storage unit 25 is the inventory amount for each denomination. The vertical axis of FIG. 9 indicates the inventory amount of a single denomination. The horizontal axis of the graph of FIG. 9 indicates the passage of time. More precisely, the horizontal axis of the graph of FIG. 9 indicates the passage of time in one week from Sunday to Saturday. As indicated as an example by two-dot-dash lines, since the change fund is withdrawn from the first money handling device 2 on a daily basis, the inventory amount of the storage unit 25 decreases over time.

The upper diagram of FIG. 9 shows that the shortage in the number of coins in the storage unit 25, with respect to a target inventory amount determined from the capacity of the storage unit 25, is set as the number of coins to be stored in the second storage unit 56 of the money depositing device 5, 500. It is expected that the inventory amount of the storage unit 25 is maintained near the target inventory amount. The target inventory amount may be set below the full capacity of the storage unit 25. Setting the target inventory amount below the full capacity prevents the storage unit 25 from exceeding its full capacity when the storage unit 25 is replenished with the coins of the money depositing device 5, 500.

The lower diagram of FIG. 9 shows that the decrement of the inventory amount of the storage unit 25 is regarded as a shortage in the number of coins, and this shortage is set the number of coins to be stored in the second storage unit 56 of the money depositing device 5, 500. It is expected that the inventory amount of the storage unit 25 is maintained constant. The decrement of the inventory amount may be set according to the frequency of replenishment of the first money handling device 2. When the replenishment is performed every day, the decrement of the inventory amount may be the decrement of the inventory amount after a lapse of one day, as shown in the lower diagram of FIG. 9.

Automatic setting of coins for replenishment reduces a burden on the staff member of the store. The first money handling device 2 can set the shortage in the number of coins accurately based on the inventory amount of the storage unit 25. The inventory amount of the storage unit 25 of the first money handling device 2 is maintained at a desired inventory amount by replenishing the storage unit 25 with the appropriate number of coins from the money depositing device 5, 500. The frequency of the replenishment of the first money handling device 2 with the change fund by the person in charge of CIT 6 is reduced. Further, since a request for replenishment is made for CIT 6 based on the inventory amount of the first money handling device 2 and the inventory amount of the money depositing device 5, 500, the amount of replenishment of the change fund by the person in charge of CIT 6 is minimized. It is possible to reduce the cost paid by the store to the CIT 6.

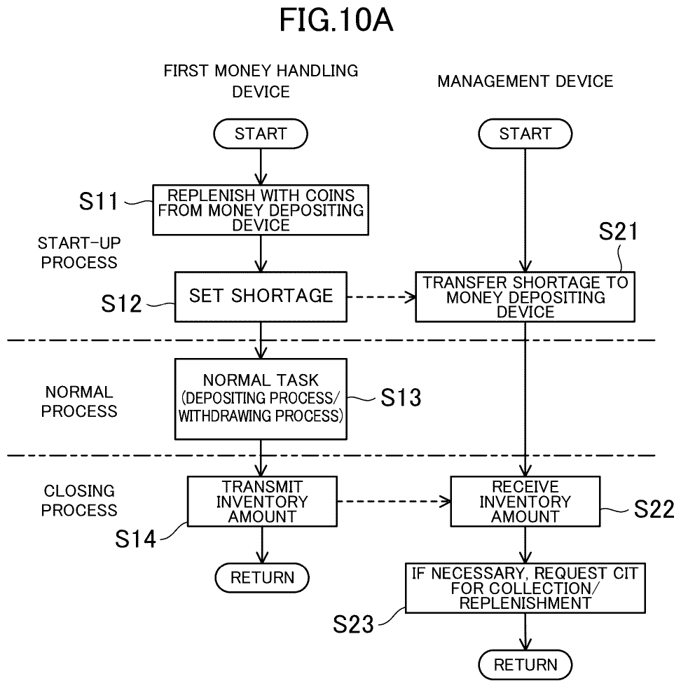

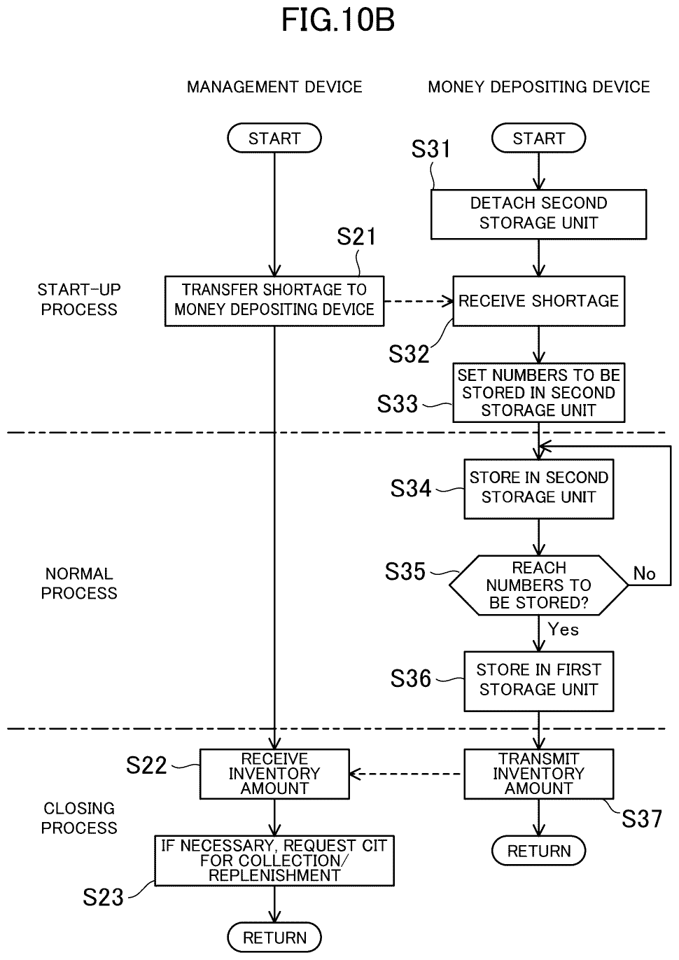

FIGS. 10A and 10B are flow charts of the process of each of the first money handling device 2, the management device 4, and the money depositing device 5, 500 in the money handling system 1. The flow charts of FIGS. 10A and 10B correspond to a case in which the first money handling device 2 is replenished every day before start of store operation.

First, as a start-up process before start of store operation, a staff member of the store detaches the second storage unit 56 from the money depositing device 5, 500 (Step S31 in FIG. 10B), and the staff member of the store replenishes the first money handling device 2 with the coins in the second storage unit 56 (Step S11 in FIG. 10A). After being replenished with the coins, the first money handling device 2 sets the shortage in the number of coins according to the above-described concept (Step S12). The first money handling device 2 transfers information on the set shortage in the number of coins to the management device 4, and the management device 4 transfers the information on the shortage in the number of coins to the money depositing device 5, 500 (Step S21 in FIGS. 10A and 10B). As described above, the information on the shortage in the number of coins is information on the shortage in the number of coins of each denomination. The money depositing device 5, 500 receives the shortage in the number of coins (Step S32 in FIG. 10B), and sets the denomination and the number of coins to be stored in the second storage unit 56 (Step S33). The start-up process is completed when the denomination and the number of coins to be stored in the second storage unit 56 are set.

A normal process subsequent to the start-up process is a normal process of each of the first money handling device 2 and the money depositing device 5, 500. The first money handling device 2 performs a process of depositing the proceeds or a process of withdrawing the change fund (Step S13 in FIG. 10A). In the normal process, the money depositing device 5, 500 stores the deposited coins preferentially in the second storage unit 56 (Step S34 in FIG. 10B). That is, the deposited coins are stored preferentially in the second storage unit 56 until the set number of coins of the set denomination is stored in the second storage unit 56 (Step S35). Once the set number of coins of the set denomination is stored in the second storage unit 56, the deposited coins are stored in the first storage unit 55 (Step S36).

In a closing process after the end of store operation, the first money handling device 2 transmits the inventory amount of the storage unit 25 to the management device 4 (Step S14 in FIG. 10A). The management device 4 receives the inventory amount of the first money handling device 2 (Step S22). The management device 4 also requests, if necessary, the CIT 6 to perform collection or replenishment for the first money handling device 2 based on the inventory amount of the first money handling device 2 (Step S23).

The money depositing device 5, 500 also transmits the inventory amounts of the first storage unit 55 and the second storage unit 56 to the management device 4 (Step S37 in FIG. 10B). The management device 4 receives the inventory amount of the money depositing device 5, 500 (Step S22). The management device 4 also requests, if necessary, the CIT 6 to perform collection for the money depositing device 5, 500 based on the inventory amount of the money depositing device 5, 500 (Step S23).

If the closing process ends, the money handling system 1 executes the above-described start-up process before start of operation on the next business day.

The management device 4 may automatically set the coins for replenishment to be stored in the second storage unit 56 of the money depositing device 5, 500, based on the inventory amount of the first money handling device 2.

### (Variations of Money Depositing Device)

In the money depositing device 5 shown in FIG. 4, the first storage unit 55 has the storage areas 551 to 558, that is, the pouches. The pouches of the first storage unit 55 and the pouch of the second storage unit 56, i.e., storage area 560, are independent of each other. If the storage areas 551 to 558 and 560 are used to store change funds for different stores, a single money depositing device 5 can be used by stores in cooperation. The memory unit 510 of the money depositing device 5 memorizes correspondence information between each of the storage areas 551 to 558 and 560 and the store.

If the stores use a single money depositing device 5 in cooperation, coupons are issued to the customer C who deposits coins in the money depositing device 5, by the stores corresponding to the storage areas 551 to 558 and 560 where the coins are stored. If the stores use the money depositing device 5 in cooperation, the management of the money depositing device 5 is facilitated by making the store issuing the coupons and the store to be replenished with the deposited coins the same store.

The coins stored in the storage areas 551 to 558 and 560 which correspond to the stores may be the set number of coins of the set denomination, similarly to the above-described case of storing coins in the second storage unit 56. Each store can store coins necessary for replenishing the first money handling device 2, in the storage area 551 to 558, 560 of the money depositing device 5.

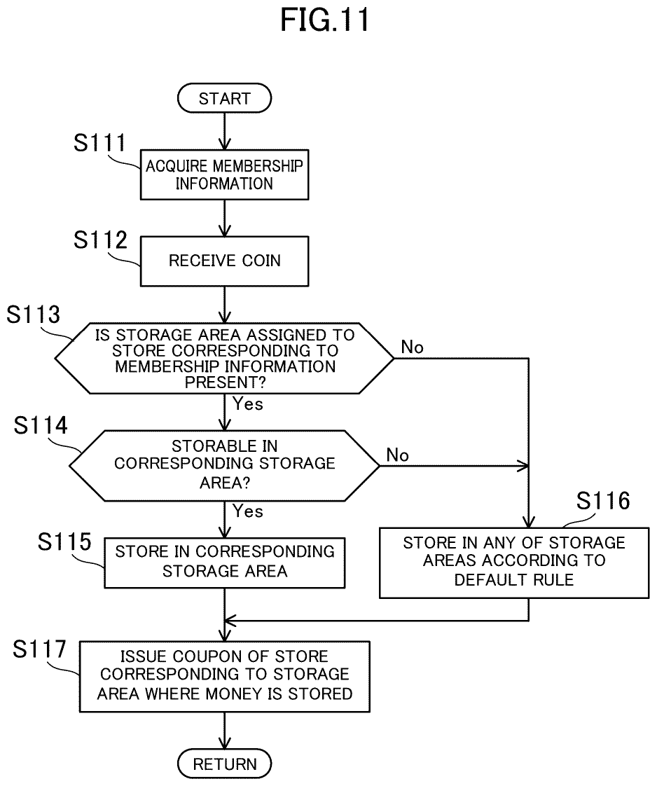

FIG. 11 is a flow chart of control of the money depositing device 5 according to the variation. After the start, in Step S111, the money depositing device 5 acquires membership information of the customer C. The customer C provides the membership information to the money depositing device 5 through the reader 58 of the money depositing device 5 using a membership card or a smartphone application of the store corresponding to a coupon the customer C desires.

Subsequently, in Step S112, the customer C inserts a coin into the money depositing device 5 through the inlet 501, and the depositing unit 51 receives the inserted coin.

In Step S113, the control unit 512 of the money depositing device 5 determines, based on the information in the memory unit 510, whether there is a storage area assigned to the store corresponding to the membership information. If there is the storage area, the control unit 512 determines, in Step S114, whether the coin can be stored in the storage area. If the coin can be stored, the control unit 512 allows the storage area to store the coin in Step S115.

On the other hand, if there is no storage area assigned to the store corresponding to the membership information in Step S113, or if the coin cannot be stored in the storage area in Step S114, the control unit 512 causes a storage area selected according to a default rule to store the coin in Step S116.

Here, the default rule may be exemplified by the following items:
select the storage area according to the order of arrangement of the storage areas in the money depositing device 5, the order of numbers assigned to the storage areas, or the order of priorities set in advance for the storage areas;
select the store (i.e., storage area) according to a time period, set in advance for each store, in which the change fund is required; and
select the store (i.e., storage area) according to the order in which the change fund is expected to be insufficient based on the inventory amounts of the first money handling device 2 and the second money handling device 3 installed in each store.

In Step S117, the money depositing device 5 issues a coupon using the printer 57. The issued coupon is a coupon of the store corresponding to the storage area where the coin is stored. The information on the coupon issued by the money depositing device 5 is transmitted from the money depositing device 5 to the management device 4 of the store corresponding to the coupon. The management device 4 of the store can manage the issuance of the coupon and the use of the coupon. The money depositing device 5 may centrally manage the information on the coupon of each store.

Here, in Step S116, the coin is not stored in the storage area corresponding to the store selected by the customer C, but is stored in the storage area of another store. The store that has issued the coupon and the store to be replenished with the coin deposited in the money depositing device 5 differ. In this case, the store corresponding to the storage area where the coin has been stored may provide money that compensates for the coupon to the store having issued the coupon, outside the money handling system 1, for example.

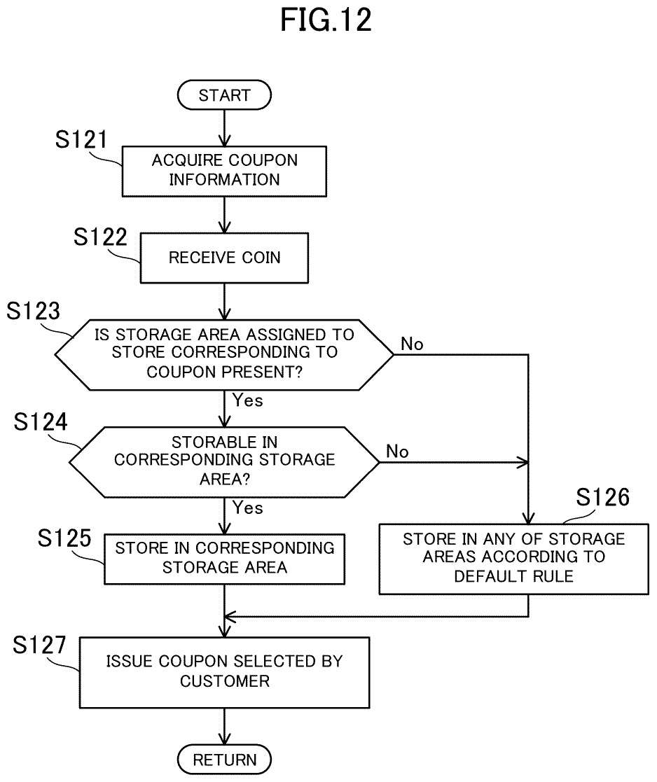

FIG. 12 is a variation of the flow chart of control of the money depositing device 5. The flow chart of control of FIG. 12 differs from the flow chart of control of FIG. 11 in that the customer C selects a desired coupon. First, after the start, in Step S121, the money depositing device 5 acquires coupon information selected by the customer C. The customer C selects the desired coupon by operating the touch panel 59.

The money depositing device 5 displays a coupon selectable by the customer C on the touch panel 59. The control unit 512 of the money depositing device 5 may change the coupon selectable by the customer C according to the inventory amounts of the first money handling device 2 and the second money handling device 3 of each store. The control unit 512 of the money depositing device 5 may also exclude, from options, a coupon of the store corresponding to the storage area into which coins cannot be stored, based on the inventory amount of the storage area for each store in the money depositing device 5. Alternatively, even if it is possible to select a coupon of the store corresponding to the storage area into which coins cannot be stored, an incentive for the customer C to select the coupon may be reduced by increasing a commission. In order to increase the chance for the customer C to select a coupon of the store corresponding to the storage area with a small amount of coins stored, the control unit 512 of the money depositing device 5 may display the option of the coupon on the touch panel 59 more conspicuously than the other options based on the inventory amount of the storage area for each store in the money depositing device 5.

In Step S122, the customer C inserts a coin into the money depositing device 5 through the inlet 501, and the depositing unit 51 receives the inserted coin.

In Step S123, the control unit 512 of the money depositing device 5 determines, based on the information in the memory unit 510, whether there is a storage area assigned to the store corresponding to the selected coupon. If there is the storage area, the control unit 512 determines, in Step S124, whether the coin can be stored in the storage area. If the coin can be stored in this storage area, the control unit 512 allows the storage area to store the coin in Step S125.

On the other hand, if there is no storage area assigned to the store corresponding to the selected coupon in Step S123, or if the coin cannot be stored in the storage area in Step S124, the control unit 512 causes an available storage area among the storage areas to store the coin according to a default rule in Step S126.

Here, the default rule may be exemplified by the items described above. Alternatively, the coin may be stored in an available storage area among the storage areas according to the order of popularity of the coupons.

In Step S127, the money depositing device 5 issues a coupon using the printer 57. The issued coupon is the coupon selected by the customer in Step S121.

Here, in Step S126, the coin is not stored in the storage area corresponding to the coupon selected by the customer C, but is stored in another storage area. As described above, the store corresponding to the storage area where the coin has been stored may provide money that compensates for the coupon to the store having issued the coupon, outside the money handling system 1, for example.

The structure of the money depositing device to which the technology disclosed herein is applicable is not limited to the structure of the money depositing device 5 described above.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

What is claimed is:

1. A money depositing device comprising:
a first storage unit that stores money received through an inlet;
a second storage unit that stores a predetermined number of items of money, received through the inlet, in at least one predetermined denomination;
a first security structure that restricts access to the first storage unit and removes a restriction on the access to the first storage unit with a first means in order to collect money stored in the first storage unit; and
a second security structure that restricts access to the second storage unit and removes a restriction on the access to the second storage unit with a second means different from the first means in order to collect money stored in the second storage unit.

2. The money depositing device of claim 1, further comprising:
a transport unit that transports money received through the inlet to the second storage unit or the first storage unit such that the predetermined number of items of money of the at least one predetermined denomination is stored preferentially in the second storage unit over the first storage unit.

3. The money depositing device of claim 1, wherein
the second storage unit stores a combination of multiple denominations of money in a single storage area in a mixed manner, the number of items of the money for each denomination being predetermined.

4. The money depositing device of claim 1, further comprising:
a reception unit that receives a denomination and the number of items of money to be stored in the second storage unit, the denomination and the number being set based on operation by a user.

5. The money depositing device of claim 1, wherein
money collected from the second storage unit is stored in a storage unit of a money handling device that performs at least a money withdrawing process,
the money depositing device further comprises a reception unit that receives a denomination and the number of items of money to be stored in the second storage unit, the denomination and the number being set based on an inventory amount of the storage unit of the money handling device.

6. The money depositing device of claim 1, wherein
the first security structure and the second security structure differ from each other in a key for a lock or a type of lock.

7. The money depositing device of claim 1, further comprising:
a housing that houses the first storage unit and the second storage unit and has an opening that is opened for the access to the first storage unit and the second storage unit, wherein
the second storage unit is located at a position closer to the opening than the first storage unit.

8. The money depositing device of claim 7, wherein
the housing further has a door which opens and closes the opening and which has a lock, and
the second storage unit is located on the door and moves along with opening and closing of the door.

9. The money depositing device of claim 8, wherein
the second storage unit has a slot used to insert money into the second storage unit, and
the second security structure has a shutter that closes the slot in conjunction with unlocking the lock of the door.

10. The money depositing device of claim 7, wherein
the second storage unit is a pouch.

11. The money depositing device of claim 1, wherein
the first storage unit includes storage areas independent of each other.

12. The money depositing device of claim 11, wherein
the storage areas of the first storage unit store money of different denominations.

13. The money depositing device of claim 1, wherein
the first storage unit and the second storage unit do not feed out money stored therein.

14. The money depositing device of claim 13, further comprising:
an issuing unit that issues a valuable medium corresponding to an amount of money received through the inlet.

15. A money depositing device comprising:
a first storage unit that stores money received through an inlet;
a second storage unit that stores a predetermined number of items of money, received through the inlet, in at least one predetermined denomination;
a housing that houses the first storage unit and the second storage unit, the housing having an opening that is opened for access to the first storage unit and the second storage unit and a door that opens and closes the opening,
the second storage unit being fixed to an inner side of the door and moving along with opening and closing of the door.
